(19) United States
(12) Patent Application Publication
(10) Pub. No.: US 2026/0266550 A1
(43) Pub. Date: Sep. 10, 2026

(54) WATER-COOLING RADIATOR WITH A DETACHABLE DRIVING STRUCTURE

(71) Applicant: Guangzhou Panli Electronic Technology Co., Ltd., Guangzhou (CN)

(72) Inventor: Xiaowen DENG, Guangzhou (CN)

(21) Appl. No.: 19/086,494

(22) Filed: Mar. 21, 2025

(30) Foreign Application Priority Data
Mar. 10, 2025 (CN) 202510277335.6

(51) Int. Cl. F28D 7/16

(52) U.S. Cl. CPC F28D 7/16

(57) ABSTRACT

The present invention discloses a water-cooling radiator with a detachable driving structure, comprising a water-cooling radiator and a water pump, wherein the water-cooling radiator comprises a first water tank, a second water tank, and a flat pipe disposed between the first water tank and the second water tank; the first water tank has a partition that divides the first water tank into a first water chamber and a second water chamber, a wall of the first water chamber and a wall of the second water chamber are provided with a first water outlet and a second water outlet, respectively, and the water pump is disposed on the wall of the first water chamber and/or the second water chamber.

### CROSS-REFERENCE TO RELATED APPLICATIONS

This application claims priority to Chinese Patent Application No. 202510277335.6, filed on Mar. 10, 2025, which is hereby incorporated by reference in its entirety.

### TECHNICAL FIELD

The present invention relates to the field of water-cooling radiator, particularly to a water-cooling radiator with a detachable driving structure.

### BACKGROUND

The water-cooling radiator has an inlet and outlet, and a plurality of water channels inside the radiator can fully utilize the advantages of water cooling to take away more heat. This is exactly the basic principle of a water-cooling radiator.

From the perspective of installation method, water-cooling devices can be divided into two types: internal water-cooling and external water-cooling. Internal water cooling device mainly consist of a radiator, a water pipe, a water pump, and sufficient water sources, indicating that most water-cooling devices have a large “volume” and require sufficient internal space in the chassis. In terms of external water-cooling radiators, all working components such as the radiator and water pump are arranged outside the chassis, which not only reducing the space occupation inside the chassis, but also providing better heat dissipation.

Existing water pumps are generally built into water-cooling plates, making the water cooling system more streamlined. However, in practical use, the vibration generated by a water pump driving the fluid affects the stability of heating components such as graphics cards and CPUs.

Of course, there are also structures that integrate the water pump into the water-cooling radiator. However, in practical use, it is difficult to disassemble and install the driving device, when damaged, which affects the stability of use.

Chinese patent CN202320592570.9, for example, makes it difficult to maintain the water pump, once damaged, and quite cumbersome to assemble.

### SUMMARY

The main objective of the present invention is to propose a water-cooling radiator with a detachable driving structure, aiming to change the existing water-cooling radiator structure, so that the driving device can be replaced or modified according to actual needs, to improve the stability of fluid operation and reduce the impact on heating elements.

To achieve the above objectives, the present invention proposes a water-cooling radiator with a detachable driving structure, comprising:
a water-cooling radiator, comprising a first water tank, a second water tank, and a flat pipe disposed between the first water tank and the second water tank;
the first water tank has a partition that divides the first water tank into a first water chamber and a second water chamber, a wall of the first water chamber and a wall of the second water chamber are provided with a first water outlet and a second water outlet, respectively, and
a water pump disposed on the wall of the first water chamber and/or the second water chamber,
the water pump comprises a base on the wall of the first water tank, a pump casing on the upper wall of the base, an impeller with a rotor, and a stator,
the base and pump casing enclose a driving chamber having a communication port, the communication port is connected to the first water outlet and/or the second water outlet, the impeller is rotatably installed in the driving chamber, and the stator is provided on the outer peripheral wall of the driving chamber to drive the rotor to rotate;
the driving chamber has an insertion port for connecting the adapter tube.

Different from existing designs, the water pump, as a module, can be directly installed on the wall of the first water tank, both the stator and rotor are brushless motors, and the stator is a magnetic induction coil that drives the rotor (permanent magnet) to rotate by controlling its electromagnetic direction, so that the fluid is being driven;
when there is one water pump, the impeller can drive the fluid from the water cooling head (in contact with the heating element) to enter the first water chamber through the insertion port, or move the fluid from the second water chamber through the insertion port in the direction of the water cooling head (in contact with the heating element);
when there are two water pumps, the fluid has more stable flow velocity, so that the motion stability of fluid is improved.

In practical design, the flow channel is simpler, that is, insertion port-driving chamber-communication port.

### BRIEF DESCRIPTION OF DRAWINGS

FIG. 1 is a three-dimensional schematic diagram of the present invention;

FIG. 2 is a sectional view of the water pump;

FIG. 3 is an exploded view of the water pump;

FIG. 4 is a top view of the water pump;

FIG. 5 is sectional view I of the water-cooling radiator;

FIG. 6 is sectional view II of the water-cooling radiator;

FIG. 7 is sectional view III of the water-cooling radiator;

FIG. 8 is a sectional view of the water pump installed on the upper wall of water-cooling radiator;

FIG. 9 is a sectional view of the water pump installed on the side wall of water-cooling radiator;

FIG. 10 is an exploded view of the water-cooling radiator;

FIG. 11 is a schematic diagram of the casing;

FIG. 12 is a three-dimensional schematic diagram of the water-cooling radiator.

Where:
1. Water-cooling radiator, 11. First water tank, 110. Partition, 111. First water chamber, 112. Second water chamber,
12. Second water tank, 13. Flat pipe,
21. First water outlet, 22. Second water outlet,
3. Water pump, 31. Base, 32. pump casing, 33. Drive chamber, 34. Communication port, 35. Insertion port, 36. Adapter pipe,
41. First sealing groove, 42. Second sealing groove,
5. First screw, 51. First screw hole, 52. Second screw hole,
6. Convex seat, 61. Driving groove, 62. Limit groove,
71. Stator, 711. PCB board, 712. Magnetic induction coil,
72. Rotor, 721. Shaft, 722. Impeller, 723. Permanent magnet, 724. Bracket,
8. Casing, 81. Side cover, 82. Side opening, 83. Clamp hole, 84. Protrusion,
9. Strip, 91. Side lug, 92. Heat dissipation fin, and 93. Slot.

### DESCRIPTION OF EMBODIMENTS

The technical solutions in the embodiments of the present invention will be described clearly and completely in conjunction with the accompanying drawings of the embodiments of the present invention. Obviously, the described embodiments are only a part of the embodiments of the present invention, rather than all the embodiments. Based on the embodiments of the present invention, all other embodiments obtained by those of ordinary skill in the art without creative work shall fall within the protection scope of the present invention.

It should be noted that all directional indicators (such as up, down, left, right, front, back, top, bottom, inside, outside, vertical, transverse, longitudinal, counterclockwise, clockwise, circumferential, radial, axial . . . ) in the embodiments of the present invention are only used to explain the relative position relationship and movement among various components in a particular posture (as shown in the accompanying drawings), and if that particular posture is changed, the directional indications will change accordingly.

In addition, descriptions involving terms “first,” “second” and the like, if any, in the present invention are only for illustrative purposes and cannot be understood as indicating or implying relative importance or the number of features referred to. Therefore, the features defined with “first” and “second” may explicitly or implicitly include at least one or a plurality of the features. At the same time, the technical solutions of various embodiments can be combined with each other, but must be based on what those of ordinary skill in the art can achieve. The combination of technical solutions that result in contradiction or make it impossible to implement should be considered non-existent, and accordingly should not fall within the scope of protection required by this present invention.

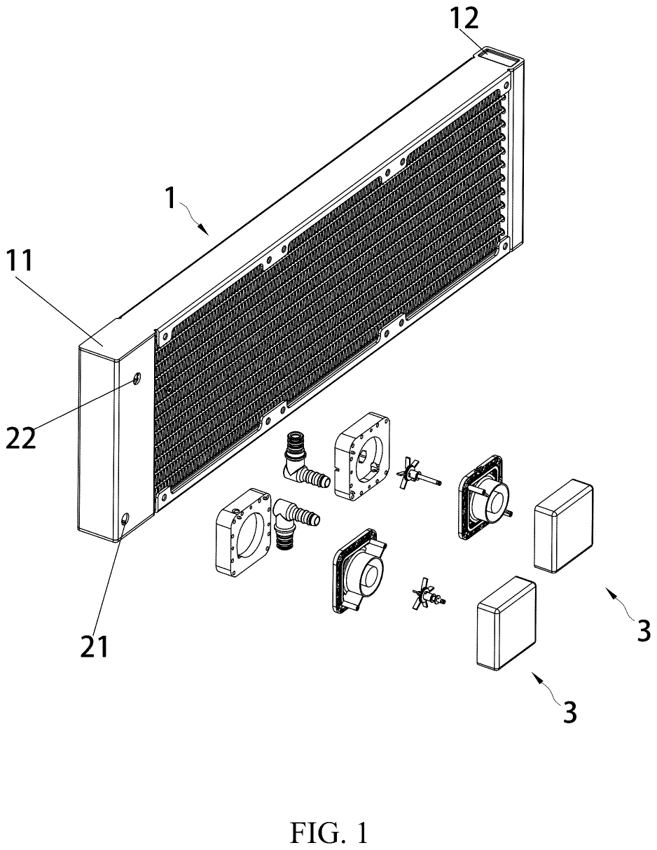

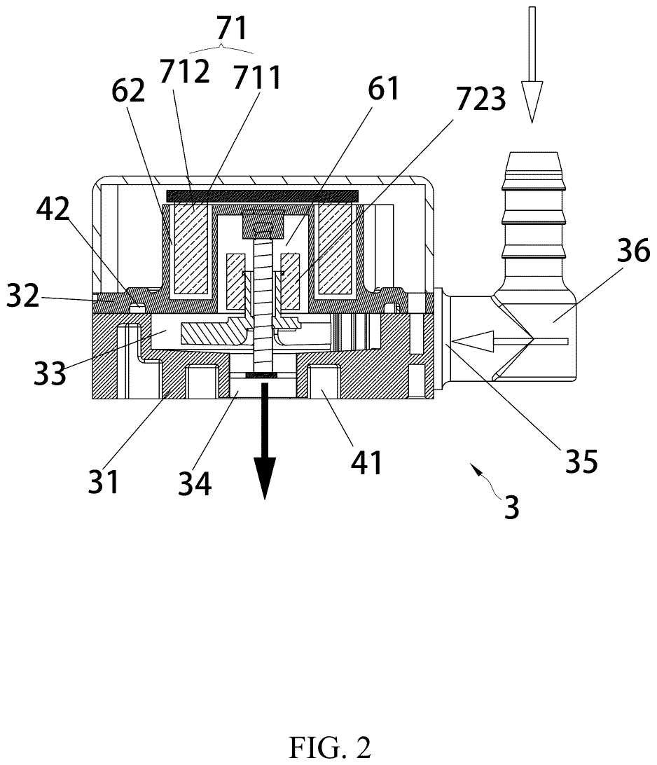

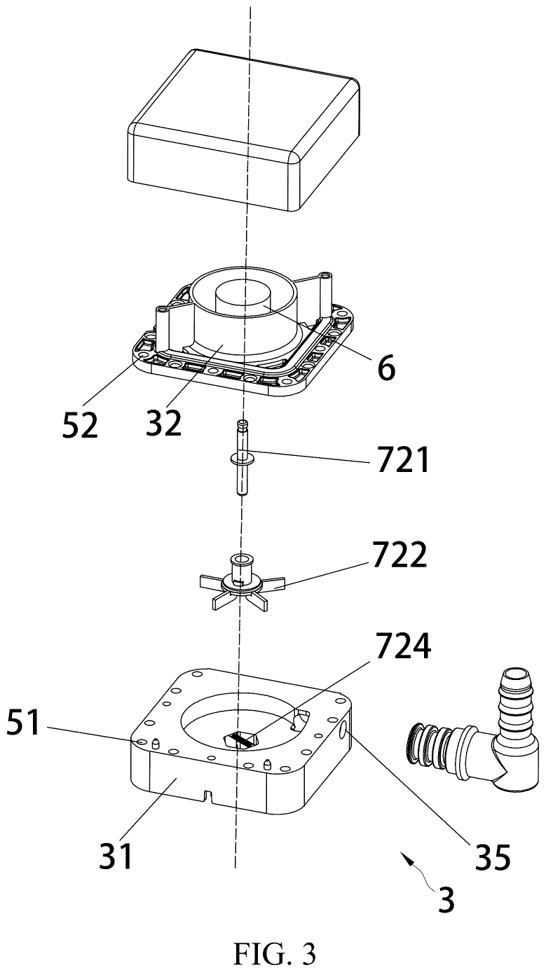

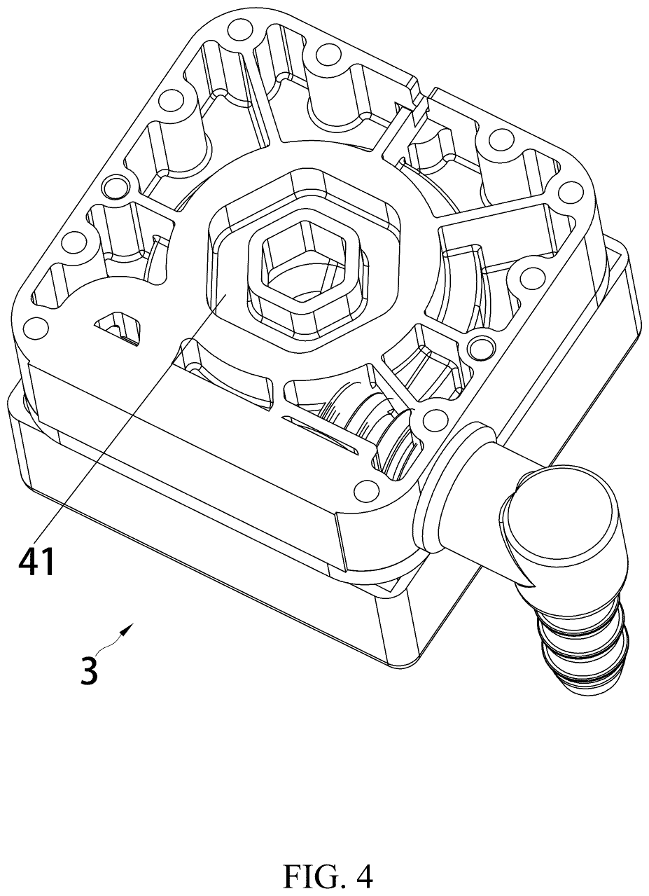

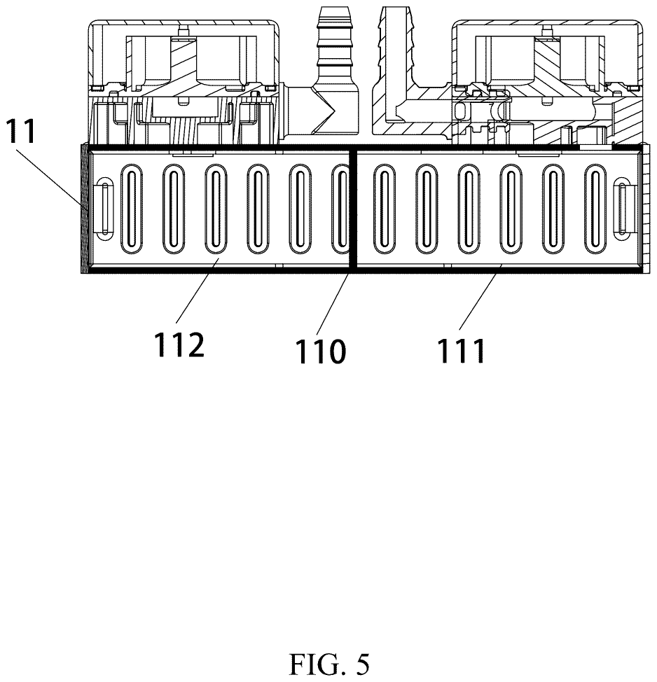

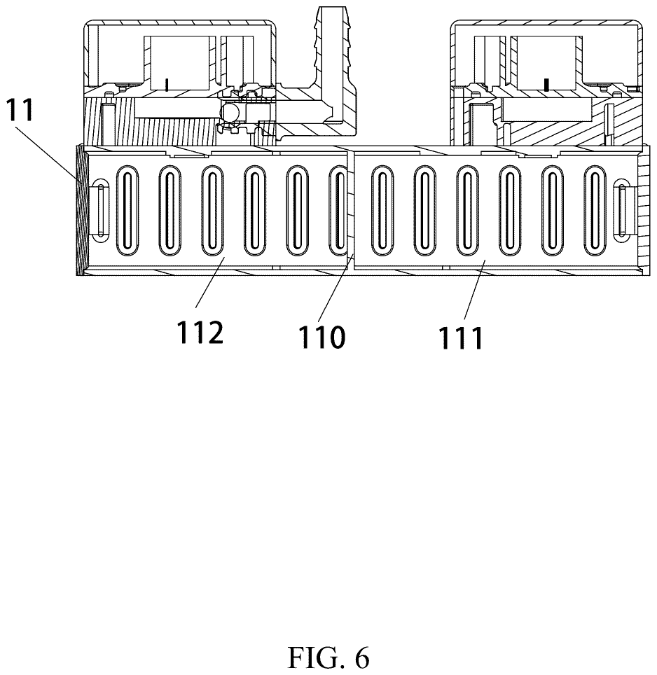

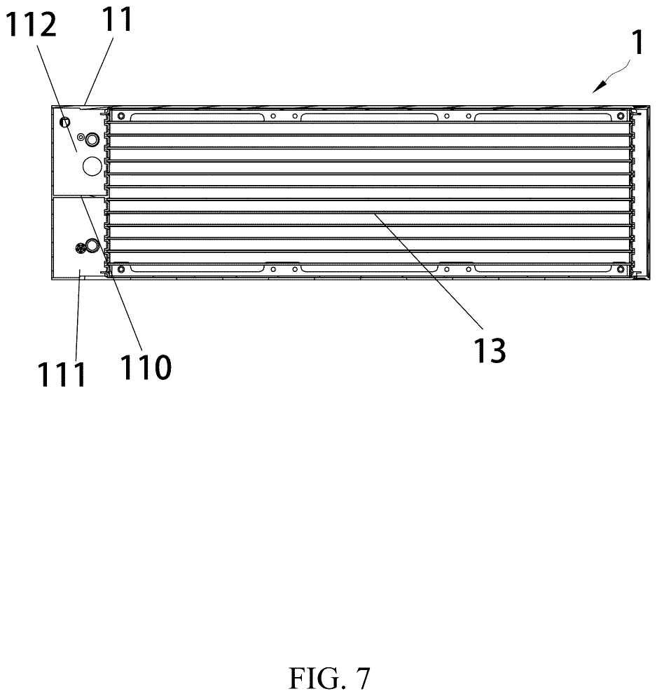

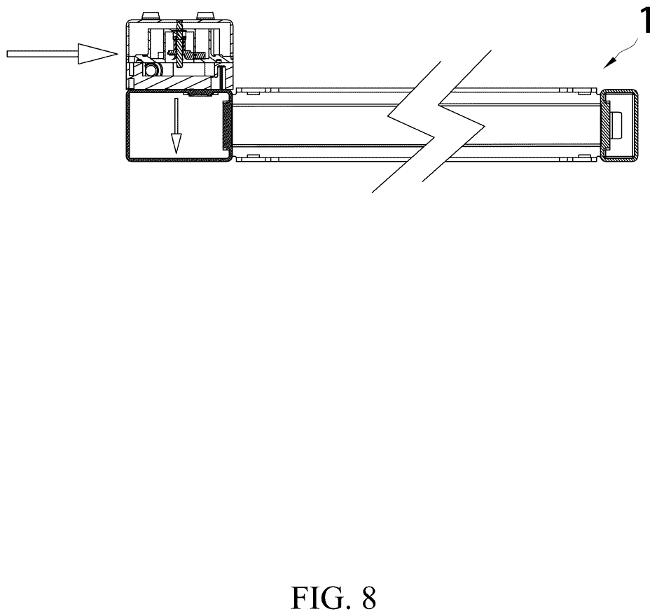

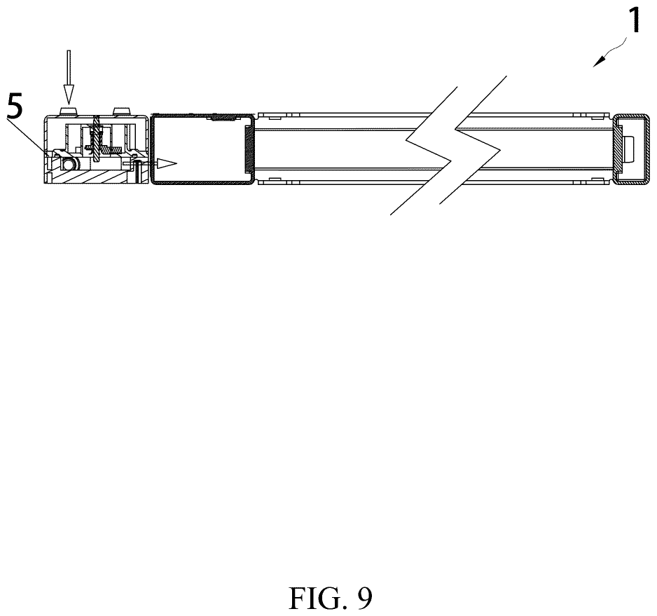

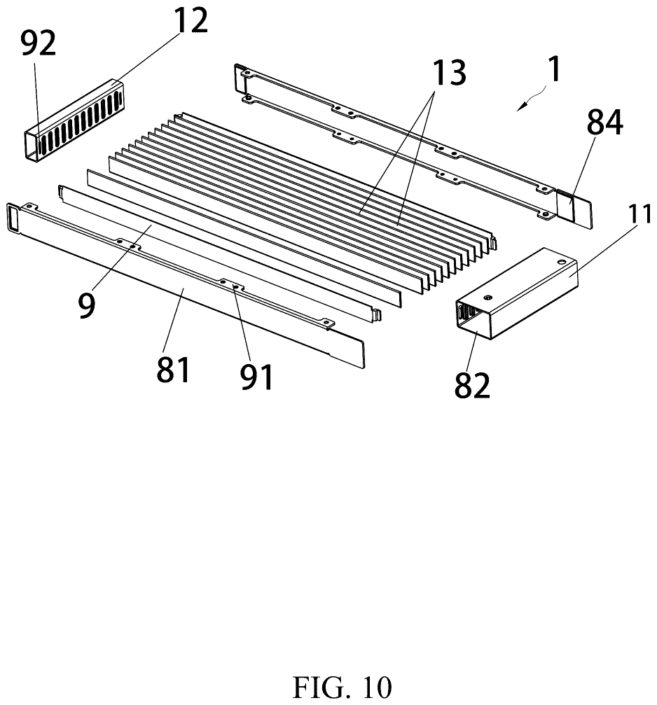

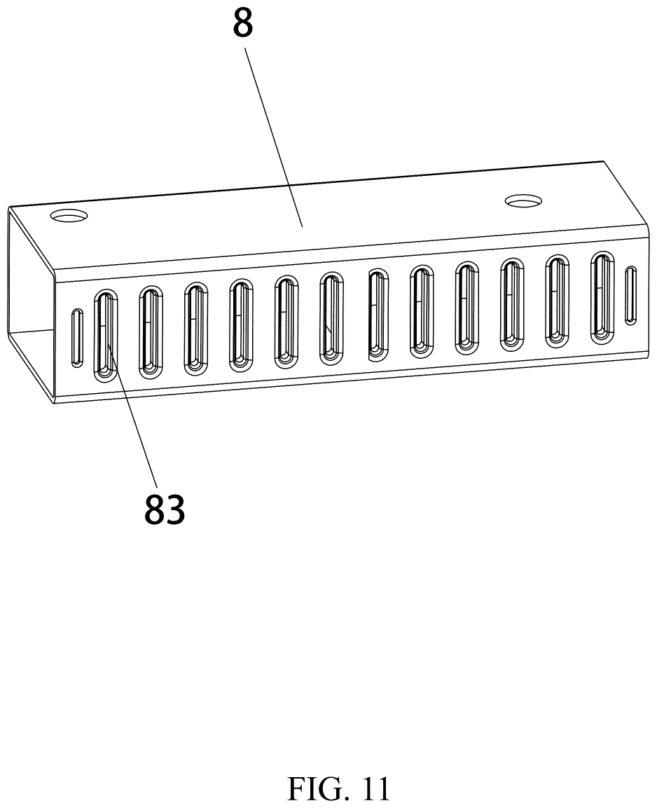

As shown in FIG. 1 to FIG. 12, a water-cooling radiator with a detachable drive structure, comprising:
a water-cooling radiator 1, comprising a first water tank 11, a second water tank 12, and a flat pipe 13 disposed between the first water tank 11 and the second water tank 12;
the first water tank 11 has a partition 110 that divides the first water tank 11 into a first water chamber 111 and a second water chamber 112, a wall of the first water chamber 111 and a wall of the second water chamber 112 are provided with a first water outlet 21 and a second water outlet 22, respectively, and
a water pump 3 disposed on the wall of the first water chamber 111 and/or the second water chamber 112,
the water pump 3 comprises a base 31 on the wall of the first water tank 11, a pump casing 32 on the upper wall of the base 31, an impeller 722 with a rotor 72, and a stator 71,
the base 31 and pump casing 32 enclose a driving chamber 33 having a communication port 34, the communication port 34 is connected to the first water outlet 21 and/or the second water outlet 22, the impeller 722 is rotatably installed in the driving chamber 33, and the stator 71 is provided on the outer peripheral wall of the driving chamber 33 to drive the rotor 72 to rotate;
the driving chamber 33 has an insertion port (the plug port 35 is used for installing the adapter tube 36) for connecting the adapter tube 36 or pipeline.

When a water pump is provided, the first water outlet or the second water outlet can be directly installed with the adapter tube.

Different from existing designs, the water pump 3, as a module, can be directly installed on the wall of the first water tank 11, both the stator 71 and rotor 72 are brushless motors, and the stator 71 is a magnetic induction coil 712 that drives the rotor 72 (permanent magnet) to rotate by controlling its electromagnetic direction, so that the fluid is being driven;
when there is one water pump 3, the impeller 722 can drive the fluid from the water cooling head (in contact with the heating element) to enter the first water chamber 111 through the insertion port, or move the fluid from the second water chamber 112 through the insertion port in the direction of the water cooling head (in contact with the heating element);
when there are two water pumps 3, the fluid has more stable flow velocity, so that the motion stability of fluid is improved.

In practical design, the flow channel is simpler, that is, insertion port—driving chamber 33—communication port 34.

Specifically, the base 31 is located on an upper wall or side wall of the first water tank 11, and the water pump 3 located on the upper wall of the first water tank 11 can be installed more simply, while the water-cooling radiator 1 is designed as a protruding structure;
when the base 31 is disposed on the side wall of the first water tank 11, the water pump 3 and the first water tank 11 can be designed with an appropriate thickness, so that the length of water-cooling radiator 1 is increased and designed as a plane as a whole, thereby enhancing the aesthetic appeal of the design.

Specifically, the communication port 34 is located on a bottom wall or side wall of the base 31, and according to the different positions of water pump 3, the water pump 3 can be disposed in different locations.

Specifically, a first sealing groove 41 is provided on an outer peripheral wall of the base 31 located at the communication port 34, and the first sealing groove 41 is used for installing a first sealing ring or applying a first sealant.

Specifically, the communication port 34 is arranged opposite to the first water outlet 21 and/or the second water outlet 22, and the first sealant ensures that the water pathway is sealed well by the mutually opposite communication port 34 and water outlet.

Specifically, the communication port 34 is provided with a hollow insertion port made of elastic material, and the insertion port partially extends into the first water outlet 21 or the second water outlet 22, and the insertion port can be preferably designed as a direct insertion structure, for example, a pagoda structure, to achieve fluid sealing.

Specifically, the base 31 is fixed to the first water tank 11 by glue, concave-convex structure, screw or buckle and, in a preferred solution, nuts are disposed on the wall of the first water tank 11, and then the base 31 is fixed to the first water tank 11 through screws.

Specifically, the upper wall of the base 31 is provided with a first screw hole 51, and the outer peripheral wall of the pump casing 32 is provided with a second screw hole 52 that fits the first screw hole 51, and the first screw 5 passes through the second screw hole 52 and is screwed into the first screw hole 51;
the position where the bottom wall of pump casing 32 contacts the upper wall of base 31 is provided with a second sealing groove 42 for installing a second sealing ring or applying a second sealant, so that the installation and sealing property of water pump 3 is assured.

Specifically, the upper wall of the pump casing 32 has a convex seat 6, and the inner wall of the convex seat 6 forms a driving groove 61, the middle of the driving groove 61 is rotatably installed with a rotating shaft 721 with an impeller 722, and the rotor 72 is a permanent magnet 723 located on the rotating shaft 721 or upper part of the impeller 722, the permanent magnet 723 is located at the position of the driving groove 61, and a limit groove 62 is provided between the outer wall of convex seat 6 and the inner wall of pump casing 32, the limit groove 62 is used for stator 71 installation, and one end of the rotating shaft 721 is clamped at the convex seat 6, or both ends of the rotating shaft 721 are clamped between the base 31 and the pump casing 32.

In the preferred embodiment, the rotating shaft 721 and the permanent magnet 723 are set as the same shaft to provide better stability of rotation and ensures coaxiality during driving and, that is, when the structure of an outer stator 71 and an inner rotor 72 is used, the magnetic induction coil 712 can also effectively reduce heat to improve the stability of rotation.

Specifically, a bracket 724 is provided in the middle of the communication hole to support the bottom end of the rotating shaft 721, and the bottom end of the rotating shaft 721 is rotatably installed on the bracket 724, and the bracket 724 can effectively improve the rotational stability of shaft 721.

Specifically, the stator 71 comprises a PCB board 711 and a magnetic induction coil 712 on the lower wall of the PCB board 711, and the PCB board 711 is detachably installed on the pump casing 32;
the upper wall of pump casing 32 is detachably provided with a decorative casing to facilitate the repair of damaged internal elements, that is, PCB board 711 can be directly detached for replacement and has a relatively small size.

Specifically, the rotating shaft 721 is a ceramic rotating shaft 721, and a ceramic bearing is provided between the rotating shaft 721, and the pump casing 32 and base 31.

Of course, in the specific setting, the upper end of rotating shaft 721 is fixed to the top wall of pump casing 32 through a clamp ring; in actual maintenance, the impeller 722 can be replaced after the pump casing 32 is disassembled and, in principle, the permanent magnet 723 of the rotor 72 has a relatively stable magnetic field and a low probability of wear.

Specifically, the first water tank 11 and the second water tank 12 are formed by stamping or aluminum extrusion moulding from a single casing and form a hollow casing 8;
the two ends of the casing 8 are provided with side openings 82;
the opposite wall surfaces of the two casings 8 are provided with clamp holes 83 for the ends of flat pipes 13;
the two ends of the casing 8 are provided with side covers 81 extending from the first water tank 11 to the second water tank 12, and the side covers 81 seal the side openings 82 of the casing 8 with sealant or through welding, therefore, in actual assembling, water-cooling radiator 1 has a simpler structure.

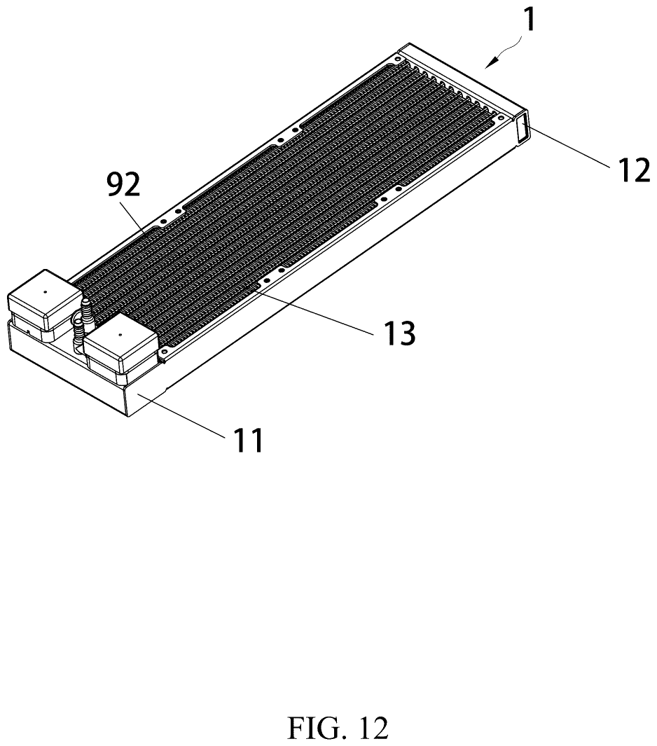

The setting of side covers makes both sides of the water-cooling radiator more pleasing in appearance, and provides better structural integration as a whole without obvious connection structure on both sides (as shown in FIG. 12), so that the structure has better stability.

Specifically, a protrusion 84 is provided for the side cover 81 at the position of side opening 82, ensuring the sealing property.

Specifically, the clamp hole 83 extends, from the outside to the inside, in an arc shape with a side portion, and an arc-shaped chamfer is provided between the side portion and the casing 8, facilitating the installation of flat pipe 13, ensuring greater contact area and improving the installation stability and convenience.

Specifically, a strip 9 is welded between the two casings 8, and the side cover 81 extends inward with a side lug 91 that is fixed to the strip 9, ensuring the frame structure of water-cooling radiator 1 and the installation of flat pipe 13, and the flat pipe 13 is fixed by sealant or welding.

Specifically, bent heat dissipation fins 92 are provided between adjacent flat pipes 13, ensuring the stable heat dissipation of water-cooling radiator 1.

Specifically, the casing 8 is concave with a slot 93, and the two ends of the strip 9 are disposed in the slot, so that the first water tank 11 and the second water tank 12 are bridged.

Specifically, two water pump 3 are provided and are located on the upper wall of the first water chamber 111 and the upper wall of the second water chamber 112, respectively.

The above are only the preferred embodiments of the present invention, and are not intended to limit the present invention. Any equivalent structural transformation made based on the description and accompanying drawings hereof under the concept of present invention, or be directly/indirectly applied in other related technical fields, should fall within scope of patent protection of the present invention.

What is claimed is:

1. A water-cooling radiator with a detachable driving structure, comprising:
a water-cooling radiator, comprising a first water tank, a second water tank, and a flat pipe disposed between the first water tank and the second water tank;
the first water tank has a partition that divides the first water tank into a first water chamber and a second water chamber, a wall of the first water chamber and a wall of the second water chamber are provided with a first water outlet and a second water outlet, respectively, and
a water pump disposed on the wall of the first water chamber and/or the second water chamber,
the water pump comprises a base on the wall of the first water tank, a pump casing on the upper wall of the base, an impeller with a rotor, and a stator,
the base and pump casing enclose a driving chamber having a communication port, the communication port is connected to the first water outlet and/or the second water outlet, the impeller is rotatably installed in the driving chamber, and the stator is provided on the outer peripheral wall of the driving chamber to drive the rotor to rotate;
the driving chamber has an insertion port for connecting the adapter tube.

2. The water-cooling radiator with a detachable driving structure according to claim 1, wherein the base is located on an upper wall or side wall of the first water tank;
the communication port is located on a bottom wall or side wall of the base.

3. The water-cooling radiator with a detachable driving structure according to claim 1, wherein a first sealing groove is provided on an outer peripheral wall of the base located at the communication port, and the first sealing groove is used for installing a first sealing ring or applying a first sealant.

4. The water-cooling radiator with a detachable driving structure according to claim 1, wherein the communication port is arranged opposite to the first water outlet and/or the second water outlet.

5. The water-cooling radiator with a detachable driving structure according to claim 1, wherein the communication port is provided with a hollow insertion port made of elastic material, and the insertion port partially extends into the first water outlet or the second water outlet.

6. The water-cooling radiator with a detachable driving structure according to claim 1, wherein the base is fixed to the first water tank by glue, concave-convex structure, screw or buckle.

7. The water-cooling radiator with a detachable driving structure according to claim 1, wherein the upper wall of the base is provided with a first screw hole, and the outer peripheral wall of the pump casing is provided with a second screw hole that fits the first screw hole, and the first screw passes through the second screw hole and is screwed into the first screw hole,
the position where the bottom wall of pump casing contacts the upper wall of base is provided with a second sealing groove for installing a second sealing ring or applying a second sealant.

8. The water-cooling radiator with a detachable driving structure according to claim 1, wherein the upper wall of the pump casing has a convex seat, and the inner wall of the convex seat forms a driving groove, the middle of the driving groove is rotatably installed with a rotating shaft with an impeller, and the rotor is a permanent magnet located on the rotating shaft or upper part of the impeller, the permanent magnet is located at the position of the driving groove, and a limit groove is provided between the outer wall of convex seat and the inner wall of pump casing, the limit groove is used for stator installation, and one end of the rotating shaft is clamped at the convex seat, or both ends of the rotating shaft are clamped between the base and the pump casing.

9. The water-cooling radiator with a detachable driving structure according to claim 8, wherein a bracket is provided in the middle of the communication hole to support the bottom end of the rotating shaft, and the bottom end of the rotating shaft is rotatably installed on the bracket.

10. The water-cooling row with a detachable driving structure according to claim 8, wherein the stator comprises a PCB board and a magnetic induction coil on the lower wall of the PCB board, and the PCB board is detachably installed on the pump casing,
the upper wall of pump casing is detachably provided with a decorative casing.

11. The water-cooling radiator with a detachable driving structure according to claim 9, wherein the rotating shaft is a ceramic rotating shaft, and a ceramic bearing is provided between the rotating shaft, and the pump casing and base.

12. The water-cooling radiator with a detachable driving structure according to claim 1, wherein the first water tank and the second water tank are formed by stamping or aluminum extrusion moulding from a single casing and form a hollow casing,
the two ends of the casing are provided with side openings;
the opposite wall surfaces of the two casings are provided with clamp holes for the ends of flat pipes;
the two ends of the casing are provided with side covers extending from the first water tank to the second water tank, and the side covers seal the side openings of the casing with sealant or through welding.

13. The water-cooling radiator with a detachable driving structure according to claim 12, wherein a protrusion is provided for the side cover at the position of side opening.

14. The water-cooling radiator with a detachable driving structure according to claim 13, wherein the clamp hole extends, from the outside to the inside, in an arc shape with a side portion, and an arc-shaped chamfer is provided between the side portion and the casing.

15. The water-cooling row with a detachable driving structure according to claim 13, wherein a strip is welded between the two casings, and the side cover extends inward with a side lug that is fixed to the strip.

16. The water-cooling radiator with a detachable driving structure according to claim 13, wherein bent heat dissipation fins are provided between adjacent flat pipes.

17. The water-cooling row with a detachable driving structure according to claim 15, wherein the casing is concave with a slot, and the two ends of the strip are disposed in the slot.

18. The water-cooling radiator with a detachable driving structure according to claim 1, wherein two water pump are provided and are located on the upper wall of the first water chamber and the upper wall of the second water chamber, respectively.

19. The water-cooling radiator with a detachable driving structure according to claim 1, wherein one water pump is provided and is located on the upper wall or side wall of the first water chamber.

20. The water-cooling radiator with a detachable driving structure according to claim 1, wherein one water pump is provided and is located on the upper wall or side wall of the second water chamber.
